(19) United States
(12) Patent Application Publication
(10) Pub. No.: US 2026/0167752 A1
(43) Pub. Date: Jun. 18, 2026

(54) NICKEL AND COBALT PBD WITH IMPROVED PROCESSABILITY

(71) Applicant: G-3 Chickadee Purchaser, LLC, Akron, OH (US)

(72) Inventors: Milad Mesgar, Beachwood, OH (US); Naresh Eedugurala, Kent, OH (US); Aaron Patrick Murray, Chardon, OH (US); Gyusaang Youn, Copley, OH (US); Gamil Gamal Attareb, Cuyahoga Falls, OH (US); Margaret Flook Vielhaber, Kent, OH (US)

(73) Assignee: G-3 Chickadee Purchaser, LLC, Akron, OH (US)

(21) Appl. No.: 19/418,644

(22) Filed: Dec. 12, 2025

Related U.S. Application Data
(60) Provisional application No. 63/733,145, filed on Dec. 12, 2024.

(51) Int. Cl. C08F 136/06; B60C 1/00; C08K 5/372; C08K 5/548

(52) U.S. Cl. CPC C08F 136/06; B60C 1/0016; B60C 1/0041; C08K 5/372; C08K 5/548

(57) ABSTRACT

A material produced via polymerizing conjugated diene monomer to generate a polydiene cement solution; terminating the polydiene cement solution with a protic organic compound; connecting polymer chains by reacting (1) a compound containing sulfur and a halogen with (2) a compound having at least one carbon-carbon unsaturated bond; and adding a product of the reaction to the cement solution to generate a new polydiene rubber.

The present application claims the benefit of U.S. Provisional Application No. 63/733,145, filed Dec. 12, 2024, which is incorporated herein by reference in its entirety.

### BACKGROUND OF THE INVENTION

1,4-Cis polybutadiene is commonly synthesized by polymerizing 1,3-butadiene using nickel-based catalyst systems. These catalyst systems typically consist of (a) an organonickel compound, (b) an organoaluminum compound, and (c) a fluorine-containing compound. Depending on the need for specific characteristic of the final rubber, in some cases, amine compounds might be present in the system too.

1,4-Cis polybutadiene produced using nickel-based catalyst systems generally has a high molecular weight and consequently high solution viscosity. As a result, the production processes might be challenging regarding fouling the reactor.

Several compounds have been identified as molecular weight reducing agents when used alongside nickel-based catalyst systems. For example, U.S. Pat. No. 4,383,097 discloses that alpha-olefins like ethylene and propylene function as molecular weight reducers when combined with these three-component nickel catalysts.

U.S. Pat. No. 4,383,097 shows that certain nonconjugated diolefins, such as 1,4-pentadiene, 1,6-heptadiene, and 1,5-hexadiene, can reduce molecular weight when used with these systems.

Additionally, Canadian Patent 1,236,648 highlights that 1-butene, isobutylene, cis-2-butene, trans-2-butene, and allene serve as molecular weight regulators in similar catalyst systems.

Moreover, U.S. Pat. No. 5,100,982 explains that 1,4-cis polybutadiene with reduced molecular weight and a broad molecular weight distribution can be synthesized using specific nickel-based catalysts in the presence of halogenated phenols, such as para-chlorophenol.

While reducing molecular weight with the aforementioned additives may seem like a viable approach, it often leads to increased cold flow or results in a product with lower Mooney viscosity, which can present challenges.

U.S. Pat. No. 5,451,646 discloses that para-styrenated diphenylamine acts as molecular weight reducing agent when employed in conjunction with nickel-based catalyst systems which contain (a) an organonickel compound, (b) an organoaluminum compound, and (c) a fluorine containing compound. U.S. Pat. No. 5,451,646 indicates that para-styrenated diphenylamine also acts to improve the processability of cis-1,4-polybutadiene rubbers prepared in its presence utilizing such nickel-based catalyst systems. In other words, para-styrenated diphenylamine can be employed in conjunction with such nickel-based catalyst systems to reduce the molecular weight of the rubber without sacrificing cold flow characteristics.

To overcome the macrostructure and process challenges at the same time, which are higher molecular weight polymer without fouling the reactor, higher molecular weight polymer with improved processability, and higher molecular weight polymer with reduced solution viscosity, a potential solution would be to target a lower molecular weight or reduced solution viscosity during the reaction phase, minimizing fouling and improving processability. Then, later in the process, the molecular weight could be increased to achieve the desired product characteristics.

It is now discovered that an additive formed by mixing of disulfur dichloride, an organic compound that carries a carbon-carbon unsaturated bond, and a solvent could be added to a terminated nickel polydiene cement and can result in a rubber with higher molecular weight. The disclosed process provides a functionalized rubber as well as improved processability. The present disclosure further relates to the processes during which the polydiene compositions are synthesized.

### SUMMARY OF THE INVENTION

The present invention provides a higher molecular weight functionalized polydiene with improved processability while maintaining and/or enhancing the performance of a downstream product incorporating such polydiene. The improved processability and performance is achieved by adding disulfur dichloride solution and an organic compound carries carbon-carbon unsaturated bonds by means of a Mooney jump additive.

One or more embodiments of this disclosure relates to a method of preparing a functionalized cis polydiene with increased molecular weight and consequently Mooney jump. According to the contemplated methods, a polymerization system of 1,4-cis polydiene is prepared by introducing a transition metal catalyst such as nickel and a conjugated diene monomer compound, which will be exposed to an additive after a termination step to show molecular weight increase and Mooney jump. A critical aspect of the invention is to promote the Mooney jump after termination of the cement.

Other embodiments of this disclosure relate to a method of preparing a functionalized polydiene with increased molecular weight and consequently Mooney jump. According to the contemplated methods, a cobalt polymerization system of polydiene is prepared by introducing a (a) an organocobalt compound, (b) a trialkylaluminum compound, and (c) hexafluoro-2-propanol. which will be exposed to an additive to show increased molecular weight and consequently Mooney jump.

As mentioned supra, the additive will comprise three components: A) disulfur dichloride (S₂Cl₂) or any of its families, such as, for example SCl₂, SOCl₂, S₂Br₂, SOBr₂ or a combination thereof; B) an organic compound bearing carbon-carbon unsaturated bond; and C) organic solvents.

In one or more embodiment of this present disclosure, an organic compound bearing carbon-carbon unsaturated bond may be defined as “silane” compounds.

In one or more embodiment of this present disclosure, an organic compound bearing carbon-carbon unsaturated bond may be defined as “siloxane” compounds.

In one or more embodiment of this present disclosure, an organic compound bearing carbon-carbon unsaturated bond may be defined as “alkenyl ether” compounds.

In one or more embodiment of this present disclosure, an organic compound bearing carbon-carbon unsaturated bond may be defined as “alkenyl esters” compounds.

In one or more embodiment of this present disclosure, an organic compound bearing carbon-carbon unsaturated bond may be defined as “acrylate” compounds.

In one or more embodiment of this present disclosure, an organic compound bearing carbon-carbon unsaturated bond may be defined as “amides” compounds.

In one or more embodiment of this present disclosure, an organic compound bearing carbon-carbon unsaturated bond may be defined as “liquid olefinic” compounds.

As mentioned supra, an organic compound bearing carbon-carbon unsaturated bond may be defined as “silane” compounds in which herein defined by the formula A:

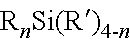

wherein n=1 to 4 and R can be hydrogen, aliphatic hydrocarbon, cycloaliphatic hydrocarbon, aromatic hydrocarbon, cycloaliphatic, a monovalent organic group or a combination(s) thereof. The R′ can be vinyl, allyl, butenyl, pentenyl, hexenyl, or generally any alkenyl or alkynyl functionalities or organic functionalities bearing unsaturated carbon-carbon bonds.

The present disclosure also relates to “silane” compounds defined by the formula B:

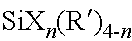

Wherein n=1 to 4 and X can be (OR), (SR), (SeR), (NR₂), (PR₂), halogens, acrylates, heterocycles, a monovalent organic group or a combination(s) thereof. The R′ can be vinyl, allyl, butenyl, pentenyl, or generally any alkenyl or alkynyl functionalities or organunctiic functionalities bearing unsaturated carbon-carbon bonds.

As mentioned supra, an organic compound bearing carbon-carbon unsaturated bond may be defined as “siloxane” compounds in which herein defined by the formula C:

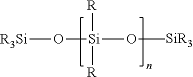

Where n=0 to 16 and R is either methyl or vinyl, allyl, butenyl, pentenyl, hexenyl, or generally any alkenyl or alkynyl functionalities or organic functionalities bearing unsaturated carbon-carbon bonds.

The present disclosure also relates to cyclic “siloxane” compounds defined by the formula D:

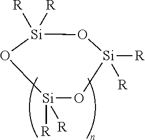

Where n=1 to 5 and R is either methyl or vinyl, allyl, butenyl, pentenyl, hexenyl, or generally any alkenyl or alkynyl functionalities or organic functionalities bearing unsaturated carbon-carbon bonds.

As mentioned supra, an organic compound bearing carbon-carbon unsaturated bond may be defined as “alkenyl ether” compounds. A critical aspect of the “alkenyl ethers” relates to allyl ethers herein defined by the formula E:

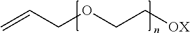

Where n=1 to 20 and X can be hydrogen, methyl, acetoxy, alkenyl, or monovalent organic group bearing unsaturated carbon-carbon bonds or the combinations thereof.

The present disclosure also relates to vinyl ether compounds defined by the formula F:

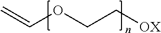

Where n=1 to 20 and X can be hydrogen, methyl, acetoxy, alkenyl, or monovalent organic group bearing unsaturated carbon-carbon bonds or the combinations thereof.

The present disclosure also relates to allyl ether compounds defined by the formula G:

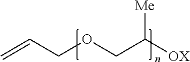

Where n=1 to 20 and X can be hydrogen, methyl, acetoxy, alkenyl, or monovalent organic group bearing unsaturated carbon-carbon bonds or the combinations thereof.

The present disclosure also relates to vinyl ether compounds defined by the formula H:

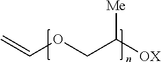

Where n=1 to 20 and X can be hydrogen, methyl, acetoxy, alkenyl, or monovalent organic group bearing unsaturated carbon-carbon bonds or the combinations thereof.

The present disclosure also relates to allyl ether compounds defined by the formula I:

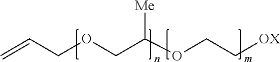

Where n=1 to 20 and X can be hydrogen, methyl, acetoxy, alkenyl, or monovalent organic group bearing unsaturated carbon-carbon bonds or the combinations thereof.

The present disclosure also relates to vinyl ether compounds defined by the formula J:

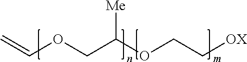

Where n=1 to 20 and X can be methyl, acetoxy, alkenyl, or monovalent organic group bearing unsaturated carbon-carbon bonds or the combinations thereof.

A critical aspect of the present disclosure relates to alkenyl ethers compounds. As used herein, alkenyl ethers defined by the formula K:

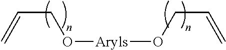

Where n=0 to 8 and aryls can be any aromatic rings (fused or non-fused rings) including heterocycles. The aryls can be with or without functionalities including but not limited to alkyl, aryl, alkoxy, halogen, hydroxyl, alkenyl, alkenyloxy, or any monovalent organic group or the combination thereof.

The present disclosure also relates to alkenyl ether compounds. As used herein, alkenyl ethers defined by the formula L:

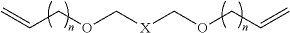

Where n=0 to 12 and X can be perfluoroaliphatic, perfluorocycloaliphatic, aliphatic, cycloaliphatic, bicycloaliphatic, and spiro aliphatic with or without functionalities including but not limited to alkyl, aryl, alkoxy, halogen, hydroxyl, alkenyl, alkenyloxy, or any monovalent organic group or the combination thereof.

As mentioned supra, an organic compound bearing carbon-carbon double bond may be defined as “alkenyl ester” compounds. As used herein, alkenyl esters defined by the formula M:

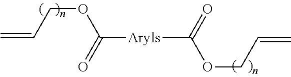

Where n=0 to 8 and aryls can be any aromatic rings (fused or non-fused rings) including heterocycles. The aryls can be with or without functionalities including but not limited to alkyl, aryl, alkoxy, halogen, hydroxyl, alkenyl, alkynyl, alkenyloxy, or any monovalent organic group or the combination thereof.

The present disclosure also relates to alkenyl esters defined by the formula N:

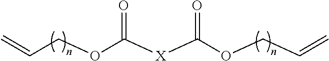

Where n=0 to 12 and X can be perfluoroaliphatic, perfluorocycloaliphatic, aliphatic, cycloaliphatic, bicycloaliphatic, and spiro aliphatic with or without functionalities including but not limited to alkyl, aryl, alkoxy, halogen, hydroxyl, alkenyl, alkynyl, alkenyloxy, or any monovalent organic group or the combination thereof.

As mentioned supra, an organic compound bearing carbon-carbon unsaturated bond may be defined as “acrylate” compounds. As used herein, “acrylate” compounds defined by the formula O:

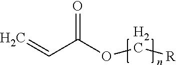

Where n=0 to 20 and R can be hydrogen, alkyl, aryl, alkenyl, alkynyl, aliphatic hydrocarbon, aliphatic perfluoro hydrocarbon, aromatic hydrocarbon, cycloaliphatic hydrocarbon, heterocycles, —COOH, —COOMe, —NR′₂, —PR′₂, —OH, —OR′, —SR′, —SiR′₃, —Si(OR′)₃, halogens, or the combinations thereof. The R′ can be any monovalent organic hydrocarbon functionalities.

The present disclosure also relates to “metacrylate” compound defined by the formula P:

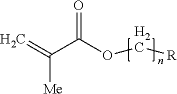

Where n=0 to 20 and R can be hydrogen, alkyl, aryl, alkenyl, alkynyl, aliphatic hydrocarbon, aliphatic perfluoro hydrocarbon, aromatic hydrocarbon, cycloaliphatic hydrocarbon, heterocycles, —COOH, —COOMe, —NR′₂, —PR′₂, —OH, —OR′, —SR′, —SiR′₃, —Si(OR′)₃, halogens, or the combinations thereof. The R′ can be any monovalent organic hydrocarbon functionalities.

A critical aspect of the present disclosure relates to “acrylamides” compound. As used herein, acrylamide defined by the formula Q:

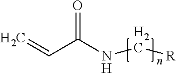

Where n=0 to 20 and R can be hydrogen, alkyl, aryl, alkenyl, alkynyl, aliphatic hydrocarbon, aliphatic perfluoro hydrocarbon, aromatic hydrocarbon, cycloaliphatic hydrocarbon, heterocycles, —COOH, —COOMe, —NR′₂, —PR′₂, —OH, —OR′, —SR′, —SiR′₃, —Si(OR′)₃, halogens, or the combinations thereof. The R′ can be any monovalent organic hydrocarbon functionalities.

A critical aspect of the present disclosure relates to “methacrylamides” compound. As used herein, defined by the formula R:

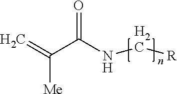

Where n=0 to 20 and R can be hydrogen, alkyl, aryl, alkenyl, alkynyl, aliphatic hydrocarbon, aliphatic perfluoro hydrocarbon, aromatic hydrocarbon, cycloaliphatic hydrocarbon, heterocycles, —COOH, —COOMe, —NR′₂, —PR′₂, —OH, —OR′, —SR′, —SiR′₃, —Si(OR′)₃, halogens, or the combinations thereof. The R′ can be any monovalent organic hydrocarbon functionalities.

As mentioned supra, an organic compound bearing carbon-carbon unsaturated bond may be defined as “amides” compounds. As used herein, “amide” compounds defined by the formula S:

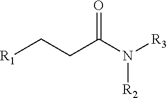

where at least one of R₁, R₂, and R₃ is any organic functional groups that contain an unsaturated carbon-carbon bond. Organic functional groups are an alkyl, cycloalkyl, aryl, heterocycles, alkenyl, alkynyl, cycloalkenyl, cycloalkynyl, —COOH, —COOMe, —NR′₂, —PR′₂, —OH, —OR′, —SR′, —SiR′₃, —Si(OR′)₃, halogens or the combination thereof in which the R′ is an alkyl or aryl group.

As mentioned supra, an organic compound bearing carbon-carbon unsaturated bond may be defined as “alkyne” compounds. As used herein, alkyne defined by the formula T:

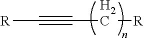

where n=2 to 20 and R can be hydrogen, alkyl, alkenyl, alkynyl, aliphatic hydrocarbon, aromatic hydrocarbon, cycloaliphatic hydrocarbon, heterocycles, —COOH, —COOMe, —NR′₂, —PR′₂, —OH, —OR′, —SR′, —SiR′₃, —Si(OR′)₃, siloxane chain with 8 units or less, halogens, or the combinations thereof.

As mentioned supra, an organic compound bearing carbon-carbon unsaturated bond may be defined as “alkyne” compounds. As used herein, alkyne defined by the formula U:

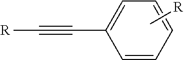

where R can be hydrogen, alkyl, alkenyl, alkynyl, aliphatic hydrocarbon, aromatic hydrocarbon, cycloaliphatic hydrocarbon, heterocycles, —COOH, —COOMe, —NR′₂, —PR′₂, —OH, —OR′, —SR′, —SiR′₃, —Si(OR′)₃, halogens, or the combinations thereof.

As mentioned supra, an organic compound bearing carbon-carbon unsaturated bond may be defined as “alkyne” compounds. As used herein, alkyne defined by the formula V:

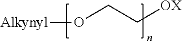

where n=1 to 20 and X can be hydrogen, methyl, acetoxy, alkenyl, alkynyl, or monovalent organic group bearing unsaturated carbon-carbon bonds or the combinations thereof.

As mentioned supra, an organic compound bearing carbon-carbon unsaturated bond may be defined as “alkyne” compounds. As used herein, alkyne defined by the formula W:

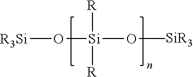

where n=0 to 16 and at least one R is an alkynyl functionality and other Rs can be hydrogen, methyl, phenyl, or monovalent organic group bearing unsaturated carbon-carbon bonds or the combinations thereof.

As mentioned supra, an organic compound bearing carbon-carbon unsaturated bond may be defined as “olefinic compounds” in which herein defined by the formula X: Liquid polydienes with vinyl content of 15 to 90% and molecular weight of 1400 to 10000 range. Representative examples of this category may be a laboratory synthesized or commercial sources such as Ricon® 130, Ricon® 131, Ricon® 134, Ricon® 138, Ricon® 300, Ricon® 142, Ricon® 150, Ricon® 152, Ricon® 153, Ricon® 154, Ricon® 156, Ricon® 157. The present disclosure also relates to “olefinic compounds” defined characterized as a liquid copolymer of styrene and dienes with vinyl content of 30 to 70% and molecular weight of 2000 to 10000. Representative examples of this category may be a laboratory synthesized or commercial sources such as Ricon® 100, Ricon® 110, Ricon® 181, Ricon® 184.

The present disclosure also related to “olefinic compounds” characterized as functionalized liquid polydienes with vinyl content of 15 to 90% and molecular weight of 1400 to 10000 range. One example can be Ricon® 603.

The present disclosure also related to “olefinic compounds” characterized as Terpenes such as Myrcene, Limonene, and Nerolidol.

The present disclosure also relates to “olefinic compounds” defined by the any cobalt or neodymium or nickel polydiene terminated cement that is diluted with an organic hydrocarbon solvent such as hexane with a viscosity of less than 300 centistokes.

The present disclosure also relates to “olefinic compounds” defined by any alkyl lithium polydiene or styrene butadiene terminated cement that is diluted with an organic hydrocarbon solvent such as hexane with a viscosity of less than 300 centistokes.

The present disclosure also relates to natural organic compound such as Falcarinol, Falcarindiol, Capillin bearing unsaturated carbon-carbon bonds.

The solvent used in the disclosed additive formulations comprises polar and non-polar organic solvents such as dodecane, dodecanol, 1,2-expoxydodecane, or dodecanoic acid.

### DETAILED DESCRIPTION OF THE INVENTION

It is now discovered that the addition of an additive to a 1,4-cis polydiene cement is the basis, at least in part, of producing a 1,4-cis polydiene with higher molecular weight and higher Mooney viscosity compared to a control sample without any additive. Another aspect of this invention is a 1,4-cis polydiene produced using such additive and that has functionalities, which later selectively may or may not increase the performance of the downstream product. The contemplated additive comprises a mixture of sulfur and a halogen, such as disulfur dichloride (S₂Cl₂) or any of its families, e.g., SCl₂, SOCl₂, S₂Br₂, SOBr₂ or a combination thereof, and a compound bearing carbon-carbon unsaturated bond, and organic solvents. Incorporation of the disclosed additive promotes either a long-chain branching of the 1,4-cis polydiene or cross-linked polydienes. Additionally, they desirably reduce the number of process steps, minimize by-product waste, and increase the efficiency of the process. Such additives should be prepared without any special or specific system design that is out of the normal practice of chemical industries.

One or more embodiments of this disclosure provide a method of preparing a branched 1,4-cis polydiene using a transition metal catalyst in which the final 1,4-cis polydiene shows significant cold flow improvement in addition to increased molecular weight and Mooney jump.

According to embodiments of this disclosure, a method comprises the steps of preparing the branched or cross-linked polymers by connecting the two polymer chains with the additive, wherein the reactor system is batched or continuous or a mix of two.

### I. Diene Monomer

The 1,4-cis polydienes may be prepared by polymerizing conjugated diene monomer using the disclosed catalyst system. Many types of unsaturated monomers, which contain carbon-carbon double bonds, can be polymerized into polymers using such metal catalysts. Elastomeric or rubbery polymers can be synthesized by polymerizing diene monomers utilizing this type of metal initiator system. The diene monomers that can be polymerized into synthetic rubbery polymers can be either conjugated or nonconjugated diolefins. Conjugated diolefin monomers containing from 4 to 8 carbon atoms are generally preferred. Vinyl-substituted aromatic monomers can also be copolymerized with one or more diene monomers into rubbery polymers, such as, for example styrene-butadiene rubber (SBR). Some representative examples of conjugated diene monomers that can be polymerized into rubbery polymers include 1,3-butadiene, isoprene, 1,3-pentadiene, 2,3-dimethyl-1,3-butadiene, 2-methyl-1,3-pentadiene, 2,3-dimethyl-1,3-pentadiene, 2-phenyl-1,3-butadiene, and 4,5-diethyl-1,3-octadiene. Some representative examples of vinyl-substituted aromatic monomers that can be utilized in the synthesis of rubbery polymers include styrene, 1-vinylnapthalene, 3-methylstyrene, 3,5-diethylstyrene, 4-propylstyrene, 2,4,6-trimethylstyrene, 4-dodecylstyrene, 3-methyl-5-normal-hexylstyrene, 4-phenylstyrene, 2-ethyl-4-benzylstyrene, 3,5-diphenylstyrene, 2,3,4,5-tetraethylstyrene, 3-ethyl-1-vinylnapthalene, 6-isopropyl-1-vinylnapthalene, 6-cyclohexyl-1-vinylnapthalene, 7-dodecyl-2-vinylnapthalene, α-methylstyrene, and the like.

There is no limitation made herein to the diene monomers employed. In one embodiment the monomer can be 1,3-butadiene, which can be polymerized and produce cis-1,4 polybutadiene. In one embodiment the monomer can be isoprene, which can be polymerized and produce cis-1,4 polybutadiene.

The polymerizations of this invention will typically be carried out as solution polymerizations in a hydrocarbon solvent which can be one or more aromatic, paraffinic, or cycloparaffinic compounds. These solvents will normally contain from 4 to about 10 carbon atoms per molecule and will be liquids under the conditions of the polymerization. Some representative examples of suitable organic solvents include isooctane, cyclohexane, normal hexane, benzene, toluene, xylene, ethylbenzene, and the like, alone or in admixture.

Polymerization is typically started by adding the nickel-based catalyst system and the alkylated diphenylamine to the polymerization medium. However, it is critical for the organoaluminum compound and the fluorine containing compound to be brought together in the presence of the alkylated diphenylamine. The organonickel compound can be brought into contact with the alkylated diphenylamine either before or after it is brought into contact with the fluorine containing compound.

In batch techniques, it is normally convenient to add the catalyst components and the alkylated diphenylamine to a polymerization medium which already contains 1,3-butadiene monomer in an organic solvent. This is preferably done by sequentially adding (1) the organoaluminum compound, (2) the alkylated diphenylamine, (3) the organonickel compound and (4) the fluorine containing compound to the polymerization medium.

Another preferred batch technique involves the sequential addition of (1) the organoaluminum compound, (2) the organonickel compound, (3) the alkylated diphenylamine and (4) the fluorine containing compound to the polymerization medium. Also, the alkylated diphenylamine can be prereacted with the fluorine containing compound with the resultant product being added to the polymerization medium.

### II. The Catalyst System

The invention disclosed here is not necessarily limited by specific transition metal-based systems. In embodiments of the disclosure, the catalyst systems used in the process of this invention is made by preforming three or four catalyst components.

For three catalyst components: (1) an organonickel or cobalt compound, (2) an organoaluminum compound, and (3) a fluorine-containing compound. In solution polymerizations of this invention, a polymerization medium comprising (4) an organic solvent may also be used.

For four catalyst components: (1) an organonickel, (2) an organoaluminum compound, (3) a fluorine-containing compound, and (4) an alkylated diphenylamine. In solution polymerizations of this invention, a polymerization medium comprising (5) an organic solvent may also be used.

The component of the catalyst which contains nickel or cobalt can be any soluble organonickel/cobalt compound. These soluble nickel/cobalt compounds are normally compounds of nickel/cobalt with a mono-dentate or bi-dentate organic ligands containing up to 20 carbon atoms. A ligand is an ion or molecule bound to and considered bonded to a metal atom or ion. Mono-dentate means having one position through which covalent or coordinate bonds with the metal may be formed. Bi-dentate means having two positions through which covalent or coordinate bonds with the metal may be formed. The term “soluble” refers to solubility in butadiene monomer and inert solvents.

Generally, any nickel salt or nickel containing organic acid containing from about 1 to 20 carbon atoms may be employed as the soluble nickel containing compound which exist in various oxidation states, including but not limited to 0, +2, +3, and +4. Some representative examples of soluble nickel containing compounds include nickel benzoate, nickel acetate, nickel naphthenate, nickel octanoate, nickel neodecanoate, bis(c-furyl dioxime) nickel, nickel palmitate, nickel stearate, nickel acetylacetonate, nickel salicaldehyde, bis(cyclopentadiene) nickel, bis(salicylaldehyde)ethylene diimine nickel, cyclopentadienyl-nickel nitrosyl, bis(π-allyl nickel), bis(π cycloocta-1,5-diene), bis(π-allyl nickel trifluoroacetate), and nickel tetracarbonyl. The preferred component containing nickel is a nickel salt of a carboxylic acid or an organic complex compound of nickel. Nickel naphthenate, nickel octanoate, and nickel neodecanoate are highly preferred soluble nickel containing compounds. Nickel 2-ethylhexanoate, which is commonly referred to as nickel octanoate (NiOct) is the soluble nickel containing compound which is most commonly used due to economic factors.

Suitable other nickel carboxylates include compounds such as nickel formate, nickel acrylate, nickel methacrylate, nickel valerate, nickel gluconate, nickel citrate, nickel fumarate, nickel lactate, nickel maleate, nickel oxalate, nickel oleate, nickel benzoate, and nickel picolinate.

The nickel salt or nickel containing organic ligands are not limited to only carboxylates. It might be nickel carboxylate borates, nickel organophosphates, nickel organophosphonates, nickel organophosphinates, nickel alkoxides or aryloxides, nickel halides, and nickel pseudo-halides.

Suitable nickel carboxylate borates include compounds defined by the formulae (RCOONiO)₃B or (RCOONiO)₂B(OR), where each R, which may be the same or different, is a hydrogen atom or a mono-valent organic group. In one embodiment, each R may be a hydrocarbyl group such as, but not limited to, alkyl, cycloalkyl, substituted cycloalkyl, alkenyl, cycloalkenyl, substituted cycloalkenyl, aryl, substituted aryl, aralkyl, alkaryl, allyl, and alkynyl groups, with each group preferably containing from 1 carbon atom, or the appropriate minimum number of carbon atoms to form the group, up to about 20 carbon atoms. These hydrocarbyl groups may contain heteroatoms such as, but not limited to, nitrogen, oxygen, silicon, sulfur, and phosphorus atoms.

Suitable nickel organophosphates include nickel dibutyl phosphate, nickel dipentyl phosphate, nickel dihexyl phosphate, nickel diheptyl phosphate, nickel dioctyl phosphate, nickel bis(1-methylheptyl)phosphate, nickel bis(2-ethylhexyl)phosphate, nickel didecyl phosphate, nickel didodecyl phosphate, nickel dioctadecyl phosphate, nickel dioleyl phosphate, nickel diphenyl phosphate, nickel bis(p-nonylphenyl)phosphate, nickel butyl(2-ethylhexyl)phosphate, nickel (1-methylheptyl)(2-ethylhexyl)phosphate, and nickel (2-ethylhexyl)(p-nonylphenyl)phosphate.

Suitable nickel organophosphonates include nickel butyl phosphonate, nickel pentyl phosphonate, nickel hexyl phosphonate, nickel heptyl phosphonate, nickel octyl phosphonate, nickel (1-methylheptyl)phosphonate, nickel (2-ethylhexyl)phosphonate, nickel decyl phosphonate, nickel dodecyl phosphonate, nickel octadecyl phosphonate, nickel oleyl phosphonate, nickel phenyl phosphonate, nickel (p-nonylphenyl)phosphonate, nickel butyl butylphosphonate, nickel pentyl pentylphosphonate, nickel hexyl hexylphosphonate, nickel heptyl heptylphosphonate, nickel octyl octylphosphonate, nickel (1-methylheptyl)(1-methylheptyl)phosphonate, nickel (2-ethylhexyl)(2-ethylhexyl)phosphonate, nickel decyl decylphosphonate, nickel dodecyl dodecylphosphonate, nickel octadecyl octadecylphosphonate, nickel oleyl oleylphosphonate, nickel phenyl phenylphosphonate, nickel (p-nonylphenyl)(p-nonylphenyl)phosphonate, nickel butyl(2-ethylhexyl)phosphonate, nickel (2-ethylhexyl)butylphosphonate, nickel (1-methylheptyl)(2-ethylhexyl)phosphonate, nickel (2-ethylhexyl)(1-methylheptyl)phosphonate, nickel (2-ethylhexyl)(p-nonylphenyl)phosphonate, and nickel (p-nonylphenyl)(2-ethylhexyl)phosphonate.

Suitable nickel organophosphinates include nickel butylphosphinate, nickel pentylphosphinate, nickel hexylphosphinate, nickel heptylphosphinate, nickel octylphosphinate, nickel (1-methylheptyl)phosphinate, nickel (2-ethylhexyl)phosphinate, nickel decylphosphinate, nickel dodecylphosphinate, nickel octadecylphosphinate, nickel oleylphosphinate, nickel phenylphosphinate, nickel (p-nonylphenyl)phosphinate, nickel dibutylphosphinate, nickel dipentylphosphinate, nickel dihexylphosphinate, nickel diheptylphosphinate, nickel dioctylphosphinate, nickel bis(1-methylheptyl)phosphinate, nickel bis(2-ethylhexyl)phosphinate, nickel didecylphosphinate, nickel didodecylphosphinate, nickel dioctadecylphosphinate, nickel dioleylphosphinate, nickel diphenylphosphinate, nickel bis(p-nonylphenyl)phosphinate, nickel butyl(2-ethylhexyl)phosphinate, nickel (1-methylheptyl)(2-ethylhexyl)phosphinate, and nickel (2-ethylhexyl)(p-nonylphenyl)phosphinate.

The organocobalt compounds utilized in the catalyst systems of this invention are typically cobalt salts of organic acids which contain from 1 to about 20 carbon atoms. Some representative examples of suitable organocobalt compounds include cobaltous benzoate, cobalt acetate, cobalt naphthenate, cobalt octanoate, cobalt stearate, and cobaltic acetylacetonate. Cobalt naphthenate and cobalt octoate are highly preferred organocobalt compounds. Cobalt 2-ethylhexanoate, which is commonly referred to as cobalt octanoate (CoOct), is the organocobalt compound which is most commonly used due to economic factors.

In one or more embodiments, organoaluminum compounds that can be utilized include those represented by the general formula AlRₙX₃₋ₙ, where each R independently can be a monovalent organic group that is attached to the aluminum atom via a carbon atom, where each X independently can be a hydrogen atom, a halogen atom (e.g., a fluorine, chlorine, bromine, or iodine atom), a carboxylate group, an alkoxide group, or an aryloxide group, and where n can be an integer in the range of from 1 to 3. Where the organoaluminum compound includes a fluorine atom, the organoaluminum compound can serve as both the alkylating agent and at least a portion of the fluorine source in the catalyst system. In one or more embodiments, each R independently can be a hydrocarbyl group such as, for example, alkyl, cycloalkyl, substituted cycloalkyl, alkenyl, cycloalkenyl, substituted cycloalkenyl, aryl, substituted aryl, aralkyl, alkaryl, allyl, and alkynyl groups, with each group containing in the range of from 1 carbon atom, or the appropriate minimum number of carbon atoms to form the group, up to about 20 carbon atoms. These hydrocarbyl groups may contain heteroatoms including, but not limited to, nitrogen, oxygen, boron, silicon, sulfur, and phosphorus atoms.

Types of the organoaluminum compounds that are represented by the general formula AlRₙX₃₋ₙ, include, but are not limited to, trihydrocarbylaluminum, dihydrocarbylaluminum hydride, hydrocarbylaluminum dihydride, dihydrocarbylaluminum carboxylate, hydrocarbylaluminum bis(carboxylate), dihydrocarbylaluminum alkoxide, hydrocarbylaluminum dialkoxide, dihydrocarbylaluminum halide, hydrocarbylaluminum dihalide, dihydrocarbylaluminum aryloxide, and hydrocarbylaluminum diaryloxide compounds. In one embodiment, the alkylating agent can comprise trihydrocarbylaluminum, dihydrocarbylaluminum hydride, and/or hydrocarbylaluminum dihydride compounds.

Suitable trihydrocarbylaluminum compounds include, but are not limited to, trimethylaluminum, triethylaluminum, triisobutylaluminum, tri-n-propylaluminum, triisopropylaluminum, tri-n-butylaluminum, tri-t-butylaluminum, tri-n-pentylaluminum, trineopentylaluminum, tri-n-hexylaluminum, tri-n-octylaluminum, tris(2-ethylhexyl)aluminum, tricyclohexylaluminum, tris(1-methylcyclopentyl)aluminum, triphenylaluminum, tri-p-tolylaluminum, tris(2,6-dimethylphenyl)aluminum, tribenzylaluminum, diethylphenylaluminum, diethyl-p-tolylaluminum, diethylbenzylaluminum, ethyldiphenylaluminum, ethyldi-p-tolylaluminum, and ethyldibenzylaluminum.

Suitable dihydrocarbylaluminum hydride compounds include, but are not limited to, diethylaluminum hydride, di-n-propylaluminum hydride, diisopropylaluminum hydride, di-n-butylaluminum hydride, diisobutylaluminum hydride, di-n-octylaluminum hydride, diphenylaluminum hydride, di-p-tolylaluminum hydride, dibenzylaluminum hydride, phenylethylaluminum hydride, phenyl-n-propylaluminum hydride, phenylisopropylaluminum hydride, phenyl-n-butylaluminum hydride, phenylisobutylaluminum hydride, phenyl-n-octylaluminum hydride, p-tolylethylaluminum hydride, p-tolyl-n-propylaluminum hydride, p-tolylisopropylaluminum hydride, p-tolyl-n-butylaluminum hydride, p-tolylisobutylaluminum hydride, p-tolyl-n-octylaluminum hydride, benzylethylaluminum hydride, benzyl-n-propylaluminum hydride, benzylisopropylaluminum hydride, benzyl-n-butylaluminum hydride, benzylisobutylaluminum hydride, and benzyl-n-octylaluminum hydride.

Suitable hydrocarbylaluminum dihydrides include, but are not limited to, ethylaluminum dihydride, n-propylaluminum dihydride, isopropylaluminum dihydride, n-butylaluminum dihydride, isobutylaluminum dihydride, and n-octylaluminum dihydride.

Suitable dihydrocarbylaluminum halide compounds include, but are not limited to, diethylaluminum chloride, di-n-propylaluminum chloride, diisopropylaluminum chloride, di-n-butylaluminum chloride, diisobutylaluminum chloride, di-n-octylaluminum chloride, diphenylaluminum chloride, di-p-tolylaluminum chloride, dibenzylaluminum chloride, phenylethylaluminum chloride, phenyl-n-propylaluminum chloride, phenylisopropylaluminum chloride, phenyl-n-butylaluminum chloride, phenylisobutylaluminum chloride, phenyl-n-octylaluminum chloride, p-tolylethylaluminum chloride, p-tolyl-n-propylaluminum chloride, p-tolylisopropylaluminum chloride, p-tolyl-n-butylaluminum chloride, p-tolylisobutylaluminum chloride, p-tolyl-n-octylaluminum chloride, benzylethylaluminum chloride, benzyl-n-propylaluminum chloride, benzylisopropylaluminum chloride, benzyl-n-butylaluminum chloride, benzylisobutylaluminum chloride, benzyl-n-octylaluminum chloride, diethylaluminum fluoride, di-n-propylaluminum fluoride, diisopropylaluminum fluoride, di-n-butylaluminum fluoride, diisobutylaluminum fluoride, di-n-octylaluminum fluoride, diphenylaluminum fluoride, di-p-tolylaluminum fluoride, dibenzylaluminum fluoride, phenylethylaluminum fluoride, phenyl-n-propylaluminum fluoride, phenylisopropylaluminum fluoride, phenyl-n-butylaluminum fluoride, phenylisobutylaluminum fluoride, phenyl-n-octylaluminum fluoride, p-tolylethylaluminum fluoride, p-tolyl-n-propylaluminum fluoride, p-tolylisopropylaluminum fluoride, p-tolyl-n-butylaluminum fluoride, p-tolylisobutylaluminum fluoride, p-tolyl-n-octylaluminum fluoride, benzylethylaluminum fluoride, benzyl-n-propylaluminum fluoride, benzylisopropylaluminum fluoride, benzyl-n-butylaluminum fluoride, benzylisobutylaluminum fluoride, and benzyl-n-octylaluminum fluoride.

Suitable hydrocarbylaluminum dihalide compounds include, but are not limited to, ethylaluminum dichloride, n-propylaluminum dichloride, isopropylaluminum dichloride, n-butylaluminum dichloride, isobutylaluminum dichloride, n-octylaluminum dichloride, ethylaluminum difluoride, n-propylaluminum difluoride, isopropylaluminum difluoride, n-butylaluminum difluoride, isobutylaluminum difluoride, and n-octylaluminum difluoride.

Other organoaluminum compounds useful as alkylating agents that may be represented by the general formula Al_{Rn}X₃₋ₙ include, but are not limited to, dimethylaluminum hexanoate, diethylaluminum octoate, diisobutylaluminum 2-ethylhexanoate, dimethylaluminum neodecanoate, diethylaluminum stearate, diisobutylaluminum oleate, methylaluminum bis(hexanoate), ethylaluminum bis(octoate), isobutylaluminum bis(2-ethylhexanoate), methylaluminum bis(neodecanoate), ethylaluminum bis(stearate), isobutylaluminum bis(oleate), dimethylaluminum methoxide, diethylaluminum methoxide, diisobutylaluminum methoxide, dimethylaluminum ethoxide, diethylaluminum ethoxide, diisobutylaluminum ethoxide, dimethylaluminum phenoxide, diethylaluminum phenoxide, diisobutylaluminum phenoxide, methylaluminum dimethoxide, ethylaluminum dimethoxide, isobutylaluminum dimethoxide, methylaluminum diethoxide, ethylaluminum diethoxide, isobutylaluminum diethoxide, methylaluminum diphenoxide, ethylaluminum diphenoxide, and isobutylaluminum diphenoxide.

Another class of organoaluminum compounds suitable for use as an alkylating agent in the present invention is aluminoxanes. Aluminoxanes can comprise oligomeric linear aluminoxanes and oligomeric cyclic aluminoxanes.

Aluminoxanes can be prepared by reacting trihydrocarbylaluminum compounds with water. This reaction can be performed according to known methods, such as, for example, (1) a method in which the trihydrocarbylaluminum compound is dissolved in an organic solvent and then contacted with water, (2) a method in which the trihydrocarbylaluminum compound is reacted with water of crystallization contained in, for example, metal salts, or water adsorbed in inorganic or organic compounds, or (3) a method in which the trihydrocarbylaluminum compound is reacted with water in the presence of the monomer or monomer solution that is to be polymerized.

Suitable aluminoxane compounds include, but are not limited to, methylaluminoxane (“MAO”), modified methylaluminoxane (“MMAO”), ethylaluminoxane, n-propylaluminoxane, isopropylaluminoxane, butylaluminoxane, isobutylaluminoxane, n-pentylaluminoxane, neopentylaluminoxane, n-hexylaluminoxane, n-octylaluminoxane, 2-ethylhexylaluminoxane, cyclohexylaluminoxane, 1-methylcyclopentylaluminoxane, phenylaluminoxane, and 2,6-dimethylphenylaluminoxane. Modified methylaluminoxane can be formed by substituting about 20 to 80 percent of the methyl groups of methylaluminoxane with C₂ to C₁₂ hydrocarbyl groups, preferably with isobutyl groups, by using techniques known to those skilled in the art.

Aluminoxanes can be used alone or in combination with other organoaluminum compounds to fulfill the second catalyst components which is the organoaluminum compounds.

The alkylated diphenylamine that can be utilized in the practice of this invention can have alkyl groups in the ortho, meta, or para positions on the phenyl groups. The alkyl groups will typically contain from 2 to 18 carbon atoms and will preferably contain from 4 to 12 carbon atoms. The alkylated diphenylamine used in the practice of this invention will typically be alkylated in the para position and will accordingly be of the structural formula:

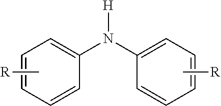

wherein R represents alkyl groups which can be the same or different and which contain from 2 to 18 carbon atoms. Mixtures of various alkylated diphenylamines which are substituted in the ortho, meta, and/or para positions can be used in the practice of this invention.

As mentioned above, the nickel-based catalyst system employed in the present invention can include a fluorine source. As used herein, the term fluorine source refers to any substance including at least one fluorine atom. In one or more embodiments, at least a portion of the fluorine source can be provided by either of the above-described nickel-containing compound and/or the above-described alkylating agent, when those compounds contain at least one fluorine atom. In other words, the nickel-containing compound can serve as both the nickel-containing compound and at least a portion of the fluorine source. Similarly, the alkylating agent can serve as both the alkylating agent and at least a portion of the fluorine source.

In one or more embodiments, at least a portion of the fluorine source can be present in the catalyst system in the form of a separate and distinct fluorine-containing compound. Fluorine-containing compounds may include various compounds, or mixtures thereof, that contain one or more labile fluorine atoms. In one or more embodiments, the fluorine-containing compound may be soluble in a hydrocarbon solvent. In other embodiments, hydrocarbon-insoluble fluorine-containing compound may be useful.

Types of fluorine-containing compounds include, but are not limited to, elemental fluorine, halogen fluorides, hydrogen fluoride, organic fluorides, inorganic fluorides, metallic fluorides, organometallic fluorides, and mixtures thereof. In one or more embodiments, complexes of the fluorine-containing compounds with a Lewis base such as ethers, alcohols, water, aldehydes, ketones, esters, nitriles, or mixtures thereof may be employed. Specific examples of these complexes include the complexes of boron trifluoride or hydrogen fluoride with a Lewis base such as hexanol.

Organic fluorides may include t-butyl fluoride, allyl fluoride, benzyl fluoride, fluoro-di-phenylmethane, triphenylmethyl fluoride, benzylidene fluoride, methyltrifluorosilane, phenyltrifluorosilane, dimethyldifluorosilane, diphenyldifluorosilane, trimethylfluorosilane, benzoyl fluoride, propionyl fluoride, and methyl fluoroformate.

Inorganic fluorides may include phosphorus trifluoride, phosphorus pentafluoride, phosphorus oxyfluoride, boron trifluoride, silicon tetrafluoride, arsenic trifluoride, selenium tetrafluoride, and tellurium tetrafluoride.

Metallic fluorides may include tin tetrafluoride, aluminum trifluoride, antimony trifluoride, antimony pentafluoride, gallium trifluoride, indium trifluoride, titanium tetrafluoride, and zinc difluoride.

Organometallic fluorides may include dimethylaluminum fluoride, diethylaluminum fluoride, methylaluminum difluoride, ethylaluminum difluoride, methylaluminum sesquifluoride, ethylaluminum sesquifluoride, isobutylaluminum sesquifluoride, methylmagnesium fluoride, ethylmagnesium fluoride, butylmagnesium fluoride, phenylmagnesium fluoride, benzylmagnesium fluoride, trimethyltin fluoride, triethyltin fluoride, di-t-butyltin difluoride, dibutyltin difluoride, and tributyltin fluoride.

The hexafluoro-2-propanol which is used in the cobalt catalyst systems of this invention is 1,1,1,3,3,3-hexafluoro-2-propanol which is of the formula: (CF₃)₂CHOH. Hexafluoro-2-propanol is also known as hexafluoroisopropyl alcohol.

A method of preparing the preformed catalyst so that it will be highly active and relatively chemically stable is to add the organoaluminum compound and the preforming agent to the solvent medium before they come into contact with the nickel compound and the alkylated diphenylamine. The nickel compound and the alkylated diphenylamine are then added to the solution with the fluoride compound being added to the solution subsequently. As an alternative, the preforming agent and the nickel compound may be mixed, followed by the addition of the organoaluminum compound, the alkylated diphenylamine and then the fluoride compound or the hydrogen fluoride/alkylated diphenylamine complex. Other orders of addition may be used but they generally produce less satisfactory results.

The amount of preforming agent used to perform the catalyst may be within the range of about 0.001 to 3 percent of the total amount of monomer to be polymerized. Expressed as a mole ratio of preforming agent to nickel compound, the amount of preforming agent present during the preforming step can be within the range of about 1 to 3000 times the concentration of nickel. The preferred mole ratio of preforming agent to nickel is about 3:1 to 500:1.

These preformed catalysts have catalytic activity immediately after being prepared. However, it has been observed that a short aging period, for example 15 to 30 minutes, at a moderate temperature, for example 50° C., increases the activity of the preformed catalyst greatly.

In order to properly stabilize the catalyst, the preforming agent must be present before the organoaluminum compound has an opportunity to react with either the nickel compound or the fluoride compound. If the catalyst system is performed without the presence of at least a small amount of preforming agent, the chemical effect of the organoaluminum upon the nickel compound or the fluoride compound is such that the catalytic activity of the catalyst is greatly lessened and shortly thereafter rendered inactive. In the presence of at least a small amount of preforming agent, the catalytic or shelf life of the catalyst is greatly improved over the system without any preforming agent present.

The four-component nickel catalyst system can also be premixed. Such premixed catalyst systems are prepared in the presence of one or more polymeric catalyst stabilizers. The polymeric catalyst stabilizer can be in the form of a liquid polymer, a polymer cement, or a polymer solution. Polymeric catalyst stabilizers are generally homopolymers of conjugated dienes or copolymers of conjugated dienes with styrenes and methyl substituted styrenes. The diene monomers used in the preparation of polymeric catalyst stabilizers normally contain from 4 to about 12 carbon atoms. Some representative examples of conjugated diene monomers that can be utilized in making such polymeric catalyst stabilizers include isoprene, 1,3-butadiene, piperylene, 1,3-hexadiene, 1,3-heptadiene, 1,3-octadiene, 2,4-hexadiene, 2,4-heptadiene, 2,4-octadiene and 1,3-nonadiene. Also included are 2,3-dimethylbutadiene, 2,3-dimethyl-1,3-hexadiene, 2,3-dimethyl-1,3-heptadiene, 2,3-dimethyl-1,3-octadiene and 2,3-dimethyl-1,3-nonadiene and mixtures thereof.

Some representative examples of polymeric catalyst stabilizers include polyisoprene, polybutadiene, polypiperylene, copolymers of butadiene and styrene, copolymers of butadiene and α-methylstyrene, copolymers of isoprene and styrene, copolymers of isoprene and α-methylstyrene, copolymers of piperylene and styrene, copolymers of piperylene and α-methylstyrene, copolymers of 2,3-dimethyl-1,3-butadiene and styrene, copolymers of 2,3-dimethyl butadiene and α-methylstyrene, copolymers of butadiene and vinyltoluene, copolymers of 2,3-dimethyl-1,3-butadiene and vinyltoluene, copolymers of butadiene and β-methylstyrene, and copolymers of piperylene and β-methylstyrene.

In order to properly stabilize the catalyst system by this premixing technique, the polymeric catalyst stabilizer must be present before the organoaluminum compound has an opportunity to react with either the nickel compound or the fluorine containing compound. The alkylated diphenylamine will, of course, be present when the organoaluminum compound is brought into contact with the fluorine containing compound. If the catalyst system is premixed without the presence of at least a small amount of polymeric catalyst stabilizer, the chemical effect of the organoaluminum compound upon the nickel compound or the fluoride compound is such that the catalytic activity of the catalyst system is greatly lessened and shortly thereafter rendered inactive. In the presence of at least a small amount of polymeric catalyst stabilizer, the catalytic or shelf life of the catalyst system is greatly improved over the same system without any polymeric catalyst stabilizer present.

One method of preparing this premixed catalyst system so that it will be highly active and relatively chemically stable is to add the organoaluminum compound to the polymer cement solution and mix thoroughly before the organoaluminum compound comes into contact with the nickel containing compound. The nickel compound is then added to the polymer cement solution. Alternatively, the nickel compound can be mixed with the polymer cement first, followed by the addition of the organoaluminum compound and the alkylated diphenylamine. Then the fluorine containing compound is added to the polymer cement solution. This is not intended to preclude other orders or methods of catalyst addition, but it is emphasized that the polymer stabilizer must be present before the organoaluminum compound has a chance to react with either the nickel containing compound or the fluorine containing compound.

The amount of polymeric catalyst stabilizer used to premix the catalyst system can be within the range of about 0.01 to 3 weight percent of the total amount monomer to be polymerized. Expressed as a weight ratio of polymeric catalyst stabilizer to nickel, the amount of polymeric catalyst stabilizer present during the premixing step can be within the range of about 2 to 2000 times the concentration of nickel. The preferred weight ratio of polymeric catalyst stabilizer to nickel is from about 4:1 to about 300:1. Even though such premixed catalyst systems show catalytic activity immediately after being prepared, it has been observed that a short aging period, for example 15 to 30 minutes, at moderate temperatures, for example 50° C., increases the activity of the preformed catalyst system.

The traditional three component nickel catalyst systems utilized in the practice of the present invention have activity over a wide range of catalyst concentrations and catalyst component ratios. The three catalyst components interact to form the active catalyst system. As a result, the optimum concentration for any one component is very dependent upon the concentrations of each of the other two catalyst components. Furthermore, while polymerization will occur over a wide range of catalyst concentrations and ratios, the most desirable properties for the polymer being synthesized are obtained over a relatively narrow range. Polymerizations can be carried out utilizing a mole ratio of the organoaluminum compound to the nickel containing compound within the range of from about 0.3:1 to about 300:1; with the mole ratio of the fluorine containing compound to the organonickel containing compound ranging from about 0.5:1 to about 200:1 and with the mole ratio of the fluorine containing compound to the organoaluminum compound ranges from about 0.4:1 to about 10:1. The preferred mole ratios of the organoaluminum compound to the nickel containing compound ranges from about 1 to about 100:1, and the preferred mole ratio of the fluorine containing compound to the organoaluminum compound ranges from about 0.7:1 to about 7:1. The concentration of the catalyst system utilized in the reaction zone depends upon factors such as purity, the reaction rate desired, the polymerization temperature utilized, the reactor design and other factors.

The amount of alkylated diphenylamine that needs to be employed as a molecular weight reducing agent varies with the catalyst system, with the polymerization temperature, and with the desired molecular weight of the high cis-1,4-polybutadiene rubber being synthesized. For instance, if a high molecular weight rubber is desired, then a relatively small amount of alkylated diphenylamine is required. On the other hand, in order to reduce molecular weights substantially, a relatively large amount of the alkylated diphenylamine will need to be employed. Generally, greater amounts of the alkylated diphenylamine are required when the catalyst system being utilized contains hydrogen fluoride or is an aged catalyst which contains boron trifluoride. However, as a general rule, from about 0.25 phm (parts by weight per hundred parts of monomer) to about 1.5 phm of the alkylated diphenylamine will be employed.

It is normally preferred to utilize 0.5 phm to 0.75 phm of the alkylated diphenylamine because at such concentrations good reductions in molecular weight can be realized. In such cases, the molecular weight of the rubber being synthesized can be controlled by adjusting the ratio of the fluorine containing compound to the organoaluminum compound. In other words, at constant levels of the alkylated diphenylamine within the range of 0.25 phm to 1.5 phm, the molecular weight of the polymer being synthesized can be controlled by varying the ratio of the fluorine containing compound to the organoaluminum compound. Maximum reductions in molecular weight and maximum conversions normally occur at molar ratios of the fluorine containing compound to the organoaluminum compound which are within the range of 1.5:1 to 2:1. At molar ratios of less than 1.5:1 and at molar ratios within the range of 2:1 to 2.75:1, lesser reductions in molecular weight occur.

The temperatures utilized in the polymerizations of this invention are not critical and may vary from extremely low temperatures to very high temperatures. For instance, such polymerizations can be conducted at any temperature within the range of about −10° C. to about 120° C. The polymerizations of this invention will preferably be conducted at a temperature within the range of 30° C. to 110° C. It is normally preferred for the polymerization to be carried out at a temperature which is within the range of about 70° C. to about 95° C. Such polymerizations will normally be conducted for a period of time which is sufficient to attain a high yield which is normally in excess of about 80% and preferably in excess of about 95%.

The cis-1,4-polybutadiene rubber made utilizing the techniques of this invention typically has a cis content in excess of about 95%. For example, the cis-1,4-polybutadiene rubber made utilizing the techniques of this invention will typically have a cis content of about 97%, a trans content of about 2%, and a vinyl content of about 1%.

The three-component cobalt catalyst systems utilized in the practice of the present invention have activity over a wide range of catalyst concentrations and catalyst component ratios. The three catalyst components interact to form the active catalyst system. As a result, the optimum concentration for any one component is very dependent upon the concentrations of each of the other two catalyst components. Furthermore, while polymerization will occur over a wide range of catalyst concentrations and ratios, the most desirable properties for the polymer being synthesized are obtained over a relatively narrow range.

Polymerizations will typically be carried out utilizing a mole ratio of the trialkylaluminum compound to the organocobalt compound which is within the range of about 5:1 to about 50:1. It is preferred for the molar ratio of the trialkylaluminum compound to the organocobalt compound to be within the range of about 10:1 to about 30:1. It is more preferred for the molar ratio of the trialkylaluminum compound to the organocobalt compound to be within the range of about 15:1 to about 25:1.

The molar ratio of the hexafluoro-2-propanol to the trialkylaluminum compound will typically be within the range of about 1:1 to about 3:1. It is normally preferred for the molar ratio of the hexafluoro-2-propanol to the trialkylaluminum compound to be within the range of about 1.2:1 to about 2:1. It is generally more preferred for the molar ratio of the hexafluoro-2-propanol to the trialkylaluminum compound to be within the range of about 1.3:1 to about 1.7:1.

The concentration of the catalyst system utilized in the reaction zone depends upon factors such as purity, the reaction rate desired, the polymerization temperature utilized, the reactor design and other factors. However, the catalyst system will normally be present in an amount whereby from about 0.0025 phm (parts by weight per 100 parts by weight of monomer) to about 0.018 phm of the organocobalt compound is present. In most cases, it is preferred for about 0.0035 phm to about 0.0095 phm of the organocobalt compound to be present. It is normally most preferred for about 0.0065 phm to about 0.0075 phm of the organocobalt compound to be present.

The temperatures utilized in the polymerizations of this invention are not critical and may vary from extremely low temperatures to very high temperatures. For instance, such polymerizations can be conducted at any temperature within the range of about −10° C. to about 130° C. The polymerizations of this invention will preferably be conducted at a temperature within the range of about 20° C. to about 100° C. It is normally preferred for the polymerization to be carried out at a temperature which is within the range of about 65° C. to about 85° C.

The cis-1,4-polybutadiene rubber made utilizing the techniques of this invention typically has a cis content in excess of about 97 percent. For example, the cis-1,4-polybutadiene rubber made utilizing the techniques of this invention will typically have a cis content of about 98 percent, a trans content of about 1 percent and a vinyl content of about 1 percent.

### III. The Additive for Mooney Jump

As used herein, an additive refers to a mixture that contains three components, the first component is disulfur dichloride (S₂Cl₂) or any of its families such as SCl₂, SOCl₂, S₂Br₂, SOBr₂ or a combination thereof. The second component is a compound having carbon-carbon unsaturated bond. The third component is an organic solvent.

For illustrative purposes only, disulfur dichloride (S₂Cl₂) will be used hereinafter as the representative of the first component but is no way limiting.

The phase of an additive can be liquid, gel, oil, and solid. In the case of solid, it will be mixed with more solvent to have a uniform liquid, gel, or oil.

In one or more embodiments, the ratio of the compound having carbon-carbon unsaturated bond (with exception of “olefinic compound” as defined earlier) to disulfur dichloride (S₂Cl₂) may be 3 to 1. In other embodiments the ratio of the compound having carbon-carbon unsaturated bond to disulfur dichloride (S₂Cl₂) may be 2 to 1. In other embodiments the ratio of the compound having carbon-carbon unsaturated bond to disulfur dichloride (S₂Cl₂) may be 1 to 1. In other embodiments the ratio of the compound having carbon-carbon unsaturated bond to disulfur dichloride (S₂Cl₂) may be 1 to 2. In other embodiments the ratio of the compound having carbon-carbon unsaturated bond to disulfur dichloride (S₂Cl₂) may be 1 to 3. In other embodiments the ratio of the compound having carbon-carbon unsaturated bond to disulfur dichloride (S₂Cl₂) may be 1 to 4.

Regarding “olefinic compounds”, the weight ratio of the “olefinic compounds” to disulfur dichloride (S₂Cl₂) may be 28 to 1. In other embodiments the weight ratio of the “olefinic compounds” to disulfur dichloride (S₂Cl₂) may be 15 to 1. In other embodiments the weight ratio of the “olefinic compounds” to disulfur dichloride (S₂Cl₂) may be 5 to 1. In other embodiments the weight ratio of the “olefinic compounds” to disulfur dichloride (S₂Cl₂) may be 1 to 1. In other embodiments the weight ratio of the “olefinic compounds” to disulfur dichloride (S₂Cl₂) may be 1 to 5. In other embodiments the weight ratio of the “olefinic compounds” to disulfur dichloride (S₂Cl₂) may be 1 to 15.

In one or more embodiments, the molarity of the compound having carbon-carbon unsaturated bond (with exception of “olefinic compound” as defined earlier) in the additive may be in the range of 0.01 to 12 molar.

Regarding “olefinic compounds”, the weight ratio of the “olefinic compounds” to solvent may be 1 to 50. In other embodiments the weight ratio of the “olefinic compounds” to solvent may be 1 to 20. In other embodiments the weight ratio of the “olefinic compounds” to solvent may be 1 to 1.

In one or more embodiments, the reaction of compound having carbon-carbon unsaturated bond (with exception of “olefinic compound” as defined earlier) and disulfur dichloride (S₂Cl₂) might not require any solvent.

In one or more embodiments, the additive may be prepared at temperature between zero and room temperature with or without agitation/stirring. In other embodiments, the additive may be prepared at temperature between zero to room temperature. In other embodiments, the additive may be prepared at temperature below 70° C. In other embodiments, the additive may be prepared at temperature between 70° C. and 120° C.

In one or more embodiments, the additive may be added 30 minutes after termination of the cement comprising the conversion of at least 95%.

In one or more embodiments, the additive may be added 15 minutes after termination of the cement comprising the conversion of at least 95%.

In one or more embodiments, the additive may be mixed with antioxidant and be added 30 minutes after termination of the cement comprising the conversion of at least 95%.

In one or more embodiments, the additive may be mixed with antioxidant and be added 15 minutes after termination of the cement comprising the conversion of at least 95%.

In one or more embodiments, the additive may be added in a different reactor than that in which the polymerization was completed.

In one or more embodiments, the additive may be added in a different reactor than that in which the polymerization was terminated.

In one or more embodiments, the amount of additive refers to a compound having carbon-carbon unsaturated bond (with exception of “olefinic compound” as defined earlier) that is being made of. Therefore, 0.1 mmol of the additive will refer to 0.1 mmol of a compound having carbon-carbon unsaturated bond (with exception of “olefinic compound” as defined earlier).

Regarding “olefinic compound”, the amount of the additive refers to the amount of disulfur dichloride that is being made of. Therefore, 0.1 mmol of the additive will refer to 0.1 mmol of disulfur dichloride.

In one or more embodiments, the amount of the additive used to prepare the branched and/or cross-linked polydienes of the present invention may be represented by the amount of the polymer present within the polymerization mixture. In one or more embodiments, the amount of the additive employed is at least 0.5 mmol, in one or more embodiments at least 1 mmol, in one or more embodiments at least 2 mmol, in one or more embodiments at least 4 mmol, in one or more embodiments at least 5 mmol, in one or more embodiments at least 6 mmol, in one or more embodiments at least 7.5 mmol per 100 g of 1,4-cis polydiene.

As mentioned supra, an additive will comprise three components, A) disulfur dichloride (S₂Cl₂) or any of its families such as SCl₂, SOCl₂, S₂Br₂, SOBr₂ or a combination thereof; B) a compound having carbon-carbon unsaturated bond; and C) organic solvents.

A critical aspect of the present disclosure relates to the silane and siloxane compounds.

Representative examples of suitable silane/siloxane to form a mooney jump additive reacting with S₂Cl₂ are, but not limited to: tetravinylsilane, trivinylsilane, phenyltris(vinyl)silane, methyltris(vinyl)silane, ethyltris(vinyl)silane, isopropyltris(vinyl)silane, chlorotris(vinyl)silane, methoxytris(vinyl)silane, ethoxytris(vinyl)silane, phenoxytris(vinyl)silane, divinylsilane, phenylbis(vinyl)silane, diphenylbis(vinyl)silane, methyl(phenyl)bis(vinyl)silane, chloro(phenyl)bis(vinyl)silane, methylbis(vinyl)silane, dimethylbis(vinyl)silane, dichlorobis(vinyl)silane, chloro(methyl)bis(vinyl)silane, diethylbis(vinyl)silane, dimethoxybis(vinyl)silane, diethoxybis(vinyl)silane, diphenoxybis(vinyl)silane, dimethylbis(vinyloxy)silane, diethylbis(vinyloxy)silane, tetravinylsilane, triallylsilane, triallyl(phenyl)silane, triallyl(methyl)silane, triallyl(chloro)silane, triallylmethoxysilane, triallylethoxysilane, diallylsilane, diallyl(phenyl)silane, diallyl(phenyl)silane, diallylbis(phenyl)silane, diallyl(methyl)(phenyl)silane, diallyl(methyl)silane, diallylbis(methyl)silane, diallyl(chloro)(methyl)silane, diallylbis(chloro)silane, diallyldimethoxysilane, diallyldiethoxysilane, bis(allyloxy)bis(phenyl)silane, bis(allyloxy)(methyl)(phenyl)silane, bis(allyloxy)bis(methyl)silane, bis(allyloxy)bis(ethyl)silane, tris(allyloxy)(methyl)silane, tetraallyl orthosilicate, [dimethyl(vinyl)siloxy]bis(methyl)(vinyl)silane, 1,1,3,3,5,5-hexamethyl-1,5-divinyltrisiloxane, 1,1,3,3,5,5,7,7-octamethyl-1,7-divinyltetrasiloxane, 1,1,3,5,5-pentamethyl-1,3,5-trivinyltrisiloxane, vinylmethylsiloxane homopolymer, methyl[methyl(vinyl)siloxy](vinyl)silane, 2,4,6,8-tetramethyl-2,4,6,8-tetravinyl-1,3,5,7,2,4,6,8-tetraoxatetrasilocane, 2,4,6,8-tetravinyl-1,3,5,7,2,4,6,8-tetraoxatetrasilocane, 2,4,6,8,10-pentamethyl-2,4,6,8,10-pentavinyl-1,3,5,7,9,2,4,6,8,10-pentaoxapentasilecane.

A critical aspect of the present disclosure relates to the alkenyl ether and alkenyl esters compounds.

Representative examples of suitable alkenyl ethers to form an additive reacting with S₂Cl₂ are, but not limited to: 2-(allyloxy)ethanol, 3-(2-methoxyethoxy)propene, 2-(allyloxy)ethyl acetate, 3-[2-(vinyloxy)ethoxy]propene, 3-[2-(allyloxy)ethoxy]propene, 2-[2-(allyloxy)ethoxy]ethanol, 2,5,8-trioxa-10-undecene, 2-[2-(allyloxy)ethoxy]ethyl acetate, 3,6,9-trioxa-1,11-dodecadiene, 4,7,10-trioxa-1,12-tridecadiene, 3,6,9-trioxa-11-dodecen-1-ol, 2,5,8,11-tetraoxa-13-tetradecene, 3,6,9-trioxa-11-dodecenyl acetate, 3,6,9,12-tetraoxa-1,14-pentadecadiene, 4,7,10,13-tetraoxa-1,15-hexadecadiene, 3,6,9,12-tetraoxa-14-pentadecen-1-ol, 2,5,8,11,14-pentaoxa-16-heptadecene, 3,6,9,12-tetraoxa-14-pentadecenyl acetate, 3,6,9,12,15-pentaoxa-1,17-octadecadiene, 4,7,10,13,16-pentaoxa-1,18-nonadecadiene, 3,6,9,12,15-pentaoxa-17-octadecen-1-ol, 2,5,8,11,14,17-hexaoxa-19-icosene, 3,6,9,12,15-pentaoxa-17-octadecenyl acetate, 3,6,9,12,15,18-hexaoxa-1,20-henicosadiene, 4,7,10,13,16,19-hexaoxa-1,21-docosadiene, 2-(vinyloxy)ethanol, (2-methoxyethoxy)ethene, 2-(vinyloxy)ethyl acetate, [2-(vinyloxy)ethoxy]ethene, 2-[2-(vinyloxy)ethoxy]ethanol, 2,5,8-trioxa-9-decene, 2-[2-(vinyloxy)ethoxy]ethyl acetate, 3,6,9-trioxa-1,10-undecadiene, 3,6,9-trioxa-10-undecen-1-ol, 2,5,8,11-tetraoxa-12-tridecene, 3,6,9-trioxa-10-undecenyl acetate, 3,6,9,12-tetraoxa-1,13-tetradecadiene, APEG 350, APEG 550, APEG 750, APEG 950, 1-(allyloxy)-2-propanol, 3-(2-methoxypropoxy)propene, 2-(allyloxy)-1-methylethyl acetate, 3-[2-(allyloxy)propoxy]propene, 3-[2-(vinyloxy)propoxy]propene, 1-[2-(allyloxy)-1-methylethoxy]-2-propanol, 3,6-dimethyl-2,5,8-trioxa-10-undecene, 2-[2-(allyloxy)-1-methylethoxy]-1-methylethyl acetate, 5,8-dimethyl-4,7,10-trioxa-1,12-tridecadiene, 4,7-dimethyl-3,6,9-trioxa-1,11-dodecadiene, 5,8-dimethyl-4,7,10-trioxa-12-tridecen-2-ol, 3,6,9-trimethyl-2,5,8,11-tetraoxa-13-tetradecene, 1,4,7-trimethyl-3,6,9-trioxa-11-dodecenyl acetate, 5,8,11-trimethyl-4,7,10,13-tetraoxa-1,15-hexadecadiene, 4,7,10-trimethyl-3,6,9,12-tetraoxa-1,14-pentadecadiene, 1-(vinyloxy)-2-propanol, (2-methoxypropoxy)ethene, 1-methyl-2-(vinyloxy)ethyl acetate, [2-(vinyloxy)propoxy]ethene, divinyl phthalate, diallyl isophthalate, diallyl terephthalate, divinyl phthalate, divinyl isophthalate, divinyl terephthalate, di3-butenyl phthalate, di3-butenyl isophthalate, di3-butenyl terephthalate, diallyl 2,6-naphthalenedicarboxylate, divinyl 2,6-naphthalenedicarboxylate, di3-butenyl 2,6-naphthalenedicarboxylate, o-bis(allyloxy)benzene, m-bis(allyloxy)benzene, p-bis(allyloxy)benzene, o-bis(vinyloxy)benzene, m-bis(vinyloxy)benzene, p-bis(vinyloxy)benzene, o-bis(3-butenyloxy)benzene, m-bis(3-butenyloxy)benzene, 2,6-bis(allyloxy) naphthalene, 2,6-bis(vinyloxy) naphthalene, 2,6-bis(3-butenyloxy) naphthalene, allyl p-{1-[p-(allyloxycarbonyl)phenyl]-1-methylethyl}benzoate, vinyl p-{1-methyl-1-[p-(vinyloxycarbonyl)phenyl]ethyl}benzoate, 3-butenyl p-{1-[p-(3-butenyloxycarbonyl)phenyl]-1-methylethyl}benzoate, p-(allyloxy) {1-[p-(allyloxy)phenyl]-1-methylethyl}benzene, p-{1-methyl-1-[p-(vinyloxy)phenyl]ethyl}(vinyloxy)benzene, p-(3-butenyloxy){1-[p-(3-butenyloxy)phenyl]-1-methylethyl}benzene, allyl 4-{1-[4-(allyloxycarbonyl)-3,5-xylyl]-1-methylethyl}-2,6-xylenecarboxylate, vinyl 4-{1-methyl-1-[4-(vinyloxycarbonyl)-3,5-xylyl]ethyl}-2,6-xylenecarboxylate, 3-butenyl 4-{1-[4-(3-butenyloxycarbonyl)-3,5-xylyl]-1-methylethyl}-2,6-xylenecarboxylate, 2-(allyloxy)-5-{1-[4-(allyloxy)-3,5-xylyl]-1-methylethyl}-m-xylene, 5-{1-methyl-1-[4-(vinyloxy)-3,5-xylyl]ethyl}-2-(vinyloxy)-m-xylene, 2-(3-butenyloxy)-5-{1-[4-(3-butenyloxy)-3,5-xylyl]-1-methylethyl}-m-xylene, allyl 4-{1-[4-(allyloxycarbonyl)-3,5-dichlorophenyl]-1-methylethyl}-2,6-dichlorobenzoate, vinyl 2,6-dichloro-4-{1-[3,5-dichloro-4-(vinyloxycarbonyl)phenyl]-1-methylethyl}benzoate, 3-butenyl 4-{1-[4-(3-butenyloxycarbonyl)-3,5-dichlorophenyl]-1-methylethyl}-2,6-dichlorobenzoate, 2-(allyloxy)-5-{1-[4-(allyloxy)-3,5-dichlorophenyl]-1-methylethyl}-1,3-dichlorobenzene, 1,3-dichloro-5-{1-[3,5-dichloro-4-(vinyloxy)phenyl]-1-methylethyl}-2-(vinyloxy)benzene, 2-(3-butenyloxy)-5-{1-[4-(3-butenyloxy)-3,5-dichlorophenyl]-1-methylethyl}-1,3-dichlorobenzene, allyl 4-{1-[4-(allyloxycarbonyl)-3,5-dibromophenyl]-1-methylethyl}-2,6-dibromobenzoate, vinyl 2,6-dibromo-4-{1-[3,5-dibromo-4-(vinyloxycarbonyl)phenyl]-1-methylethyl}benzoate, 3-butenyl 2,6-dibromo-4-{1-[3,5-dibromo-4-(3-butenyloxycarbonyl)phenyl]-1-methylethyl}benzoate, 2-(allyloxy)-5-{1-[4-(allyloxy)-3,5-dibromophenyl]-1-methylethyl}-1,3-dibromobenzene, 1,3-dibromo-5-{1-[3,5-dibromo-4-(vinyloxy)phenyl]-1-methylethyl}-2-(vinyloxy)benzene, 2-(3-butenyloxy)-5-{1-[4-(3-butenyloxy)-3,5-dibromophenyl]-1-methylethyl}-1,3-dibromobenzene, diallyl 1,2-cyclopropanedicarboxylate, divinyl 1,2-cyclopropanedicarboxylate, di3-butenyl 1,2-cyclopropanedicarboxylate, 3-[2-(allyloxy)cyclopropoxy]propene, [2-(vinyloxy)cyclopropoxy]ethene, 4-[2-(3-butenyloxy)cyclopropoxy]-1-butene, diallyl 1,3-cyclobutanedicarboxylate, divinyl 1,3-cyclobutanedicarboxylate, di3-butenyl 1,3-cyclobutanedicarboxylate, 3-[3-(allyloxy)cyclobutoxy]propene, 1,3-bis(vinyloxy)cyclobutene, 4-[3-(3-butenyloxy)cyclobutoxy]-1-butene, diallyl 1,3-cyclopentanedicarboxylate, divinyl 1,3-cyclopentanedicarboxylate, di3-butenyl 1,3-cyclopentanedicarboxylate, 1,3-bis(allyloxy)cyclopentane, 1,3-bis(vinyloxy)cyclopentane, 4-[3-(3-butenyloxy)cyclopentyloxy]-1-butene, diallyl 1,4-cyclohexanedicarboxylate, divinyl 1,4-cyclohexanedicarboxylate, di3-butenyl 1,4-cyclohexanedicarboxylate, 1,4-bis(allyloxy)cyclohexane, 1,4-bis(vinyloxy)cyclohexane, 1,4-bis(3-butenyloxy)cyclohexane, 1-(allyloxycarbonylcarbonyloxy)propene, (vinyloxycarbonylcarbonyloxy)ethene, 1-(3-butenyloxycarbonylcarbonyloxy)-3-butene, 3-(allyloxy)propene, (vinyloxy)ethene, 4-(3-butenyloxy)-1-butene, diallyl malonate, divinyl malonate, di3-butenyl malonate, 3-[(allyloxy)methoxy]propene, [(vinyloxy)methoxy]ethene, 4-[(3-butenyloxy)methoxy]-1-butene, diallyl succinate, divinyl succinate, di3-butenyl succinate, diallyl fumarate, divinyl fumarate, 1,4-bis(allyloxy)-2-butene, 1,4-bis(vinyloxy)-2-butene, diallyl glutarate, divinyl glutarate, di3-butenyl glutarate, 3-[3-(allyloxy)propoxy]propene, [3-(vinyloxy)propoxy]ethene, 4-[3-(3-butenyloxy)propoxy]-1-butene, diallyl adipate, divinyl adipate, di3-butenyl adipate, 3-[4-(allyloxy)butoxy]propene, [4-(vinyloxy)butoxy]ethene, 4-[4-(3-butenyloxy)butoxy]-1-butene, diallyl heptanedioate, divinyl heptanedioate, di3-butenyl heptanedioate, 3-[5-(allyloxy)pentyloxy]propene, [5-(vinyloxy)pentyloxy]ethene, 4-[5-(3-butenyloxy)pentyloxy]-1-butene, diallyl octanedioate, divinyl octanedioate, di3-butenyl octanedioate, 3-[6-(allyloxy)hexyloxy]propene, [6-(vinyloxy)hexyloxy]ethene, 4-[6-(3-butenyloxy)hexyloxy]-1-butene, diallyl nonanedioate, divinyl nonanedioate, di3-butenyl nonanedioate, diallyl decanedioate, divinyl decanedioate, di3-butenyl decanedioate.

A critical aspect of the present disclosure relates to the acrylate compounds.

As used herein, the representative examples of suitable acrylate compounds are, but not limited to: acrylic acid, methacrylic acid, methyl acrylate, methyl methacrylate, ethyl acrylate, ethyl methacrylate, butyl acrylate, butyl methacrylate, propyl acrylate, propyl methacrylate, isobutyl acrylate, isobutyl methacrylate, tert-butyl acrylate, tert-butyl methacrylate, isopentyl acrylate, isopentyl methacrylate, hexyl acrylate, hexyl methacrylate, 2-ethylhexyl acrylate, 2-ethylhexyl methacrylate, dodecyl acrylate, dodecyl methacrylate, tridecyl acrylate, tridecyl methacrylate, tetradecyl acrylate, tetradecyl methacrylate, hexadecyl acrylate, hexadecyl methacrylate, octadecyl acrylate, octadecyl methacrylate, 2,2,2-trifluoroethyl acrylate, 2,2,2-trifluoroethyl methacrylate, pentadecafluoro-n-octyl acrylate, pentadecafluoro-n-octyl methacrylate, tridecafluoro-n-octyl acrylate, tridecafluoro-n-octyl methacrylate, heptadecafluorodecyl acrylate, heptadecafluorodecyl methacrylate, tetrafluoropropyl acrylate, tetrafluoropropyl methacrylate, octafluoropentyl acrylate, octafluoropentyl methacrylate, 2-cyanoethyl acrylate, 2-cyanoethyl methacrylate, 2-hydroxyethyl acrylate, 2-hydroxyethyl methacrylate, 2-methoxyethyl acrylate, 2-methoxyethyl methacrylate, 4-hydroxybutyl acrylate, 4-hydroxybutyl methacrylate, hydroxypropyl acrylate, hydroxypropyl methacrylate, allyl acrylate, allyl methacrylate, 2-(2-ethoxyethoxy)-ethyl acrylate, 2-(2-ethoxyethoxy)-ethyl methacrylate, mono(2-acryloyloxyethyl) succinate, mono(2-methacryloyloxyethyl) succinate, 2-(dimethylamino)ethyl acrylate, 2-(dimethylamino)ethyl methacrylate, 2-phenoxyethyl acrylate, 2-phenoxyethyl methacrylate, cyclohexyl acrylate, cyclohexyl methacrylate, cyclohexyl acrylate, cyclohexyl methacrylate, tetrahydrofurfuryl acrylate, tetrahydrofurfuryl methacrylate, 3-(acryloyloxy)-2-hydroxypropyl methacrylate, 3-(methacryloyloxy)-2-hydroxypropyl methacrylate, 3-(acryloyloxy)-2-hydroxypropylacrylate, 2,3-dibromopropyl acrylate, 2,3-dibromopropyl methacrylate, 3-(trimethoxysilyl)propyl acrylate, 3-(trimethoxysilyl)propyl methacrylate, n-succinimidyl acrylate, n-succinimidyl methacrylate, dicyclopentanyl acrylate, dicyclopentanyl methacrylate, isobornyl acrylate, isobornyl methacrylate, 2-(trifluoromethyl)acrylic acid, 2-(trifluoromethyl)methacrylic acid, hexafluoroisopropyl methacrylate, vinyl methacrylate, 2-(acetoacetyloxy)ethyl methacrylate, hydroxypropyl methacrylate, 2-(2-methoxyethoxy)ethyl methacrylate, cyclohexyl methacrylate, benzyl methacrylate, 2-(dimethylamino)ethyl methacrylate, 2-(diethylamino)ethyl methacrylate, glycidyl methacrylate, furfuryl methacrylate, mevalonic lactone methacrylate, 3-chloro-2-hydroxypropyl methacrylate, 2-(trimethylsilyloxy)ethyl methacrylate, 3-(triethoxysilyl)propyl methacrylate, 3-[tris(trimethylsilyloxy)silyl]-propyl methacrylate, 3-[diethoxy(methyl)silyl]-propyl methacrylate, 2,2,6,6-tetramethyl-4-piperidyl methacrylate, 1,2,2,6,6-pentamethyl-4-piperidyl methacrylate, 2-methyl-2-adamantyl 2-ethyl-2-adamantyl methacrylate, 2-[2-hydroxy-5-[2-(methacryloyloxy)-ethyl]phenyl]-2 h-benzotriazole, acrylamide, n-isopropylacrylamide, n-tert-butylacrylamide, n-dodecylacrylamide, n-(butoxymethyl)acrylamide, n-(hydroxymethyl)acrylamide, n-(2-hydroxyethyl)acrylamide, 6-acrylamidohexanoic acid, diacetone acrylamide, 2-acrylamido-2-methylpropanesulfonic acid, n,n-dimethylacrylamide, n,n-diethylacrylamide, n-[3-(dimethylamino)propyl]acrylamide, 4-acryloylmorpholine, n-phenylacrylamide, methacrylamide, n-methylmethacrylamide, n-tert-butylmethacrylamide, n-(methoxymethyl)methacrylamide, n-(3-dimethylaminopropyl)methacrylamide, n,n-dimethylmethacrylamide, n-phenylmethacrylamide, n-(4-hydroxyphenyl)methacrylamide, 3-methacrylamidophenylboronic acid, tetramethylene glycol diacrylate, pentamethylene glycol diacrylate, hexamethylene glycol diacrylate, nonamethylene glycol diacrylate, decamethylene glycol diacrylate, neopentyl glycol diacrylate, 2,2,3,3,4,4,5,5-octafluorohexamethylene diacrylate, tetraethylene glycol diacrylate, dipropylene glycol diacrylate, tripropylene glycol diacrylate, ethylene glycol dimethacrylate, 1,3-butylene glycol dimethacrylate, 1,6-hexanediol dimethacrylate, neopentyl glycol dimethacrylate, diethylene glycol dimethacrylate, triethylene glycol dimethacrylate, glycerol dimethacrylate, polyethylene glycol dimethacrylate (n=4), n,n′-methylenebismethacrylamide, bisphenol a dimethacrylate, pentaerythritol tetraacrylate, 1,3,5-triacryloylhexahydro-1,3,5-triazine, trimethylolpropane triacrylate, trimethylolpropane trimethacrylate, tris(2-acryloyloxyethyl) isocyanurate.

A critical aspect of the present disclosure relates to the olefinic compounds. As used herein, “olefinic compounds” mean:
A) Liquid polydienes with vinyl content of 15 to 90% and molecular weight of 1400 to 10000 range. Representative examples of this category may be a laboratory synthesized or commercial sources such as Ricon® 130, Ricon® 131, Ricon® 134, Ricon® 138, Ricon® 300, Ricon® 142, Ricon® 150, Ricon® 152, Ricon® 153, Ricon® 154, Ricon® 156, Ricon® 157.
B) Liquid copolymer of styrene and dienes with vinyl content of 30 to 70% and molecular weight of 2000 to 10000. Representative examples of this category may be a laboratory synthesized or commercial sources such as Ricon® 100, Ricon® 110, Ricon® 181, Ricon® 184.
C) Functionalized liquid polydienes with vinyl content of 15 to 90% and molecular weight of 1400 to 10000 range. One example can be Ricon® 603.
D) Terpenes such as Myrcene, Limonene, and Nerolidol.
E) Any cobalt or neodymium or nickel polydiene terminated cement that is diluted with an organic hydrocarbon solvent such as hexane with a viscosity of less than 300 centistokes.
F) Any alkyl lithium polydiene or styrene butadiene terminated cement that is diluted with an organic hydrocarbon solvent such as hexane with a viscosity of less than 300 centistokes.

### Final Polymer

In one or more embodiments, the final polymers may have a 1,2-linkage content that is less than 1.5% where the percentages are based upon the number of dienes mer units adopting the 1,2-linkage versus the total number of diene mer units. In one or more embodiments, these polymers may have a 1,2-linkage content that is from about 0.05% to about 1.5%. The cis-1,4-, 1,2-, and trans-1,4-linkage contents can be determined by infrared spectroscopy.

In one or more embodiments, the number average molecular weight (Mn) of the cis-1,4-polydiene polymers may be from about 25,000 to about 700,000, and more preferably from about 50,000 to about 350,000, and most preferably about 125,000 to about 250,000 as determined using size exclusion chromotography (SEC). In the contemplated embodiment, the 1,4-cis polydiene is characterized by a Mooney viscosity measurement (ML1+4 at 100° C.) from about 20 to about 150 and, most preferably from 40 to about 65.

In one embodiment, the polymer may be 1,4-cis polybutadiene rubber (BR). The BR may be conveniently characterized, for example, by having at least a 90 percent cis 1,4-content. In one embodiment, the polymer is functionalized. In another embodiment, the polymer is not.

The final polymer may be compounded into a rubber composition.

The 1,4-cis polydienes, or elastomers or rubber compositions of this invention may be incorporated into various articles of manufacture, for example tires and industrial rubber products, may be prepared using such rubber compositions. Upon vulcanization, such a rubber composition may be incorporated into a pneumatic or non-pneumatic tire, belt, hose, air spring, shoe product or motor mount. In the case of a tire, the rubber composition may be incorporated in a variety of rubber tire components, such as, for example, a tread (including tread cap and/or tread base), sidewall, apex, chafer, sidewall, insert, wirecoat and/or innerliner. In one embodiment, the compound is a tread. In yet further embodiments, the composition can be used in adhesives.

A pneumatic tire of the present invention may be a race tire, passenger tire, aircraft tire, agricultural, earthmover, off-the-road, truck tire, and the like.

This invention is illustrated by the following examples that are merely for the purpose of illustration and are not to be regarded as limiting the scope of the invention or the manner in which it can be practiced. Unless specifically indicated otherwise, parts and percentages are given by weight.

### Representative Experiments

### Additive Preparation (Method 1)

In a 20 mL glass vial with rubber septa cap, was added a magnetic stirrer bar, 0.93 g of 1,1,3,3-tetramethyl-1,3-divinyldisiloxane (CAS #2627-95-4), and 2 mL of 1,2-epoxydodecane. The vial was purged with dry nitrogen gas for about 30 seconds and immediately closed. To the vial was added 1.35 g of disulfur dichloride (S₂Cl₂) and was allowed to stir at 70° C. for 60 minutes. Then was added 13 mL of 1,2-epoxydodecane and was allowed to stir for another 2-5 minutes. The content of the vial was approximately 17 mL of an oily homogenous mixture. By visual observation and monitoring, the mixture showed relative increase in viscosity or thickness throughout the time of the reaction in addition to showing a slightly darker color by passing time. The mixture is ready to be used and can be added to a terminated nickel or cobalt cement. Different amounts of the mixture will be taken out by a syringe and a needle and subsequently be added to the neodymium cement bottle.

### Experiment 1 (Control)

An oven-dried 8 oz glass bottle with rubber septa cap was purged with dry nitrogen. The bottle was charged with 140 g of butadiene solution in hexane (14.5% wt premix). To the bottle, about 1 mL of triisobutylaluminum solution (1.0M in toluene) was added followed by 0.15 mL of nickel octoate (11% wt in hexane) and 3.85 mL of HF solution (2% wt in dibutyl ether). The bottle was tumbled for 90 minutes in a water bath maintained at 65° C. The polymerization was terminated with 2.5 mL stearic acid solution 2% in hexane. The bottle was tumbled for another 10-20 minutes and then 2 mL of water in addition to 2 mL of 1% Irganox 1520 solution in isopropanol solution. The bottle was allowed for another 10-20 minutes tumbling and then was poured to a plate for drying and subsequent vacuum oven-drying. The yield of the polymer was 19.4 g (95.8%). The Mooney viscosity result (ML1+4 at 100° C.) came at 57 by using a Monsanto Mooney viscometer with a large rotor, a one-minute warm-up time, and a four-minute running time. As determined by Asymmetric flow field-flow fractionation (AF4), the polymer had a number average molecular Weight (Mn) of 167,000 g/mole, a weight average molecular weight (Mw) of 790,500 g/mole, and a molecular weight distribution (Mw/Mn) of 4.73. GPC data is not reported here. The infrared spectroscopic analysis of the polymer indicated a 1,4-cis-linkage content of >95%, and a 1,2-linkage content of <2%.

### Experiment 2

An oven-dried 8 oz glass bottle with rubber septa cap was purged with dry nitrogen. The bottle was charged with 140 g of butadiene solution in hexane (14.5% wt premix). To the bottle, about 1 mL of triisobutylaluminum solution (1.0M in toluene) was added followed by 0.15 mL of nickel octoate (11% wt in hexane) and 3.85 mL of HF solution (2% wt in dibutyl ether). The bottle was tumbled for 90 minutes in a water bath maintained at 65° C. The polymerization was terminated with 2.5 mL stearic acid solution 2% in hexane. The bottle was tumbled for another 20 minutes. As discussed above, the additive preparation (method 1), 0.5 mL of that oily mixture was added to the bottle and was allowed to stir for 20-30 minutes. Then 2 mL of water in addition to 2 mL of 1% solution of Irganox 1520 in isopropanol were added. The bottle was allowed to tumble for another 10-20 minutes and then was poured to a plate for drying and subsequent vacuum oven-drying. The yield of the polymer was 19.9 g (98.2%). The Mooney viscosity result (ML1+4 at 100° C.) came at 118 by using a Monsanto Mooney viscometer with a large rotor, a one-minute warm-up time, and a four-minute running time. GPC data is not reported here.

### Experiment 3

An oven-dried 8 oz glass bottle with rubber septa cap was purged with dry nitrogen. The bottle was charged with 140 g of butadiene solution in hexane (14.5% wt premix). To the bottle, about 1 mL of triisobutylaluminum solution (1.0M in toluene) was added followed by 0.15 mL of nickel octoate (11% wt in hexane) and 3.85 mL of HF solution (2% wt in dibutyl ether). The bottle was tumbled for 90 minutes in a water bath maintained at 65° C. The polymerization was terminated with 2.5 mL stearic acid solution 2% in hexane. The bottle was tumbled for another 20 minutes. As discussed above, the Mooney jump additive formation, 1.5 mL of that oily mixture was added to the bottle and was allowed to stir for 20-30 minutes. Then 2 mL of water in addition to 2 mL of 1% solution of Irganox 1520 in isopropanol were added. The bottle was allowed to tumble for another 10-20 minutes and then was poured to a plate for drying and subsequent vacuum oven-drying. The yield of the polymer was 20.4 g (˜100%). The Mooney viscosity result (ML1+4 at 100° C.) came at 136 by using a Monsanto Mooney viscometer with a large rotor, a one-minute warm-up time, and a four-minute running time. GPC data is not reported here.

### Experiment 4

An oven-dried 8 oz glass bottle with rubber septa cap was purged with dry nitrogen. The bottle was charged with 140 g of butadiene solution in hexane (14.5% wt premix). To the bottle, about 1 mL of triisobutylaluminum solution (1.0M in toluene) was added followed by 0.15 mL of nickel octoate (11% wt in hexane) and 3.85 mL of HF solution (2% wt in dibutyl ether). The bottle was tumbled for 90 minutes in a water bath maintained at 65° C. The polymerization was terminated with 2.5 mL stearic acid solution 2% in hexane. The bottle was tumbled for another 20 minutes. As discussed above, the Mooney jump additive formation, 2.5 mL of that oily mixture was added to the bottle and was allowed to stir for 20-30 minutes. Then 2 mL of water in addition to 2 mL of 1% solution of Irganox 1520 in isopropanol were added. The bottle was allowed to tumble for another 10-20 minutes and then was poured to a plate for drying and subsequent vacuum oven-drying. The yield of the polymer was 20.3 g (˜100%). The Mooney viscosity result (ML1+4 at 100° C.) came at 159 by using a Monsanto Mooney viscometer with a large rotor, a one-minute warm-up time, and a four-minute running time. GPC data is not reported here.

### Additive Preparation (Method 2)

In a 20 mL glass vial with rubber septa cap, was added a magnetic stirrer bar, 1.01 g of triethylene glycol divinyl ether (CAS #765-12-8), and 3 mL of 1,2-epoxydodecane. The vial was purged with dry nitrogen gas for about 30 seconds and immediately closed. To the vial was added 1.35 g of disulfur dichloride (S₂Cl₂) and was allowed to stir at 70° C. for 45 minutes. Then was added 12.2 mL of 1,2-epoxydodecane and was allowed to stir for another 2-5 minutes. The content of the vial was approximately 17 mL of an oily homogenous mixture. By visual observation and monitoring, the mixture showed a relative increase in viscosity or thickness throughout the time of the reaction in addition to showing a slightly darker color by passing time. The mixture is ready to be used and can be added to a terminated neodymium cement or an anionic butadiene/SBR cement. Different amounts of the mixture will be taken out by a syringe and a needle and subsequently be added to the neodymium cement bottle.

### Experiment 5

An oven-dried 8 oz glass bottle with rubber septa cap was purged with dry nitrogen. The bottle was charged with 140 g of butadiene solution in hexane (14.5% wt premix). To the bottle, about 1 mL of triisobutylaluminum solution (1.0M in toluene) was added followed by 0.15 mL of nickel octoate (11% wt in hexane) and 3.85 mL of HF solution (2% wt in dibutyl ether). The bottle was tumbled for 90 minutes in a water bath maintained at 65° C. The polymerization was terminated with 2.5 mL stearic acid solution 2% in hexane. The bottle was tumbled for another 20 minutes. As discussed above, the additive preparation (method 2), 1.0 mL of that oily mixture was added to the bottle and was allowed to stir for 20-30 minutes. Then 2 mL of water in addition to 2 mL of 1% solution of Irganox 1520 in isopropanol were added. The bottle was allowed to tumble for another 10-20 minutes and then was poured to a plate for drying and subsequent vacuum oven-drying. The yield of the polymer was 19.9 g (98.2%). The Mooney viscosity result (ML1+4 at 100° C.) came at 71 by using a Monsanto Mooney viscometer with a large rotor, a one-minute warm-up time, and a four-minute running time. GPC data is not reported here.

### Experiment 6

An oven-dried 8 oz glass bottle with rubber septa cap was purged with dry nitrogen. The bottle was charged with 140 g of butadiene solution in hexane (14.5% wt premix). To the bottle, about 1 mL of triisobutylaluminum solution (1.0M in toluene) was added followed by 0.15 mL of nickel octoate (11% wt in hexane) and 3.85 mL of HF solution (2% wt in dibutyl ether). The bottle was tumbled for 90 minutes in a water bath maintained at 65° C. The polymerization was terminated with 2.5 mL stearic acid solution 2% in hexane. The bottle was tumbled for another 20 minutes. As discussed above, the additive preparation (method 2), 1.7 mL of that oily mixture was added to the bottle and was allowed to stir for 20-30 minutes. Then 2 mL of water in addition to 2 mL of 1% solution of Irganox 1520 in isopropanol were added. The bottle was allowed to tumble for another 10-20 minutes and then was poured to a plate for drying and subsequent vacuum oven-drying. The yield of the polymer was 19.9 g (98.2%). The Mooney viscosity result (ML1+4 at 100° C.) came at 100 by using a Monsanto Mooney viscometer with a large rotor, a one-minute warm-up time, and a four-minute running time. GPC data is not reported here.

### Experiment 7

An oven-dried 8 oz glass bottle with rubber septa cap was purged with dry nitrogen. The bottle was charged with 140 g of butadiene solution in hexane (14.5% wt premix). To the bottle, about 1 mL of triisobutylaluminum solution (1.0M in toluene) was added followed by 0.15 mL of nickel octoate (11% wt in hexane) and 3.85 mL of HF solution (2% wt in dibutyl ether). The bottle was tumbled for 90 minutes in a water bath maintained at 65° C. The polymerization was terminated with 2.5 mL stearic acid solution 2% in hexane. The bottle was tumbled for another 20 minutes. As discussed above, the additive preparation (method 2), 1.7 mL of that oily mixture was added to the bottle and was allowed to stir for 20-30 minutes. Then 2 mL of water in addition to 2 mL of 1% solution of Irganox 1520 in isopropanol were added. The bottle was allowed to tumble for another 10-20 minutes and then was poured to a plate for drying and subsequent vacuum oven-drying. The yield of the polymer was 19.9 g (98.2%). The Mooney viscosity result (ML1+4 at 100° C.) came at 134 by using a Monsanto Mooney viscometer with a large rotor, a one-minute warm-up time, and a four-minute running time. GPC data is not reported here.

Variations in the present invention are possible in view of the description provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A method for forming a polymer, comprising:
polymerizing dienes in presence of an organonickel or cobalt catalyst to generate a solution;
terminating the solution using a protic organic compound; and
reacting the solution with a separately prepared additive mixture comprising (a) a compound containing sulfur and a halogen and (b) a compound having at least one carbon-carbon unsaturated bond.

2. The method of claim 1, wherein the polymer is prepared by:
polymerizing conjugated diene monomer at temperatures of 25° C. to 125° C. in presence of nickel carboxylate or nickel phosphate or nickel alkoxides/aryloxide or nickel carboxylate borates or nickel halides, a saturated aliphatic or alicyclic organic hydrocarbon solvent, and an alkylating agent based on aluminum.

3. The method of claim 1, wherein the polymer is prepared by:
polymerizing conjugated diene in the presence of (a) at least one cobalt compound selected from the group consisting of organocobalt compounds and cobalt complexes of an organic acid, (b) a trialkylaluminum compound, and (c) hexafluoro-2-propanol.

4. The method of claim 1, wherein the compound containing sulfur and a halogen is disulfur dichloride (S₂Cl₂), sulfur dichloride, disulfur dibromide, sulfur dibromide, thionyl chloride, thionyl bromide or a combination thereof.

5. The method of claim 1, wherein the unsaturated bond is a carbon-carbon double bond.

6. The method of claim 1, wherein the unsaturated bond is a carbon-carbon triple bond.

7. The method of claim 1, wherein the compound having at least one carbon-carbon unsaturated bond is silane or siloxane compound.

8. The method of claim 1, wherein the compound having at least one carbon-carbon unsaturated bond is an alkenyl ether compound or an alkenyl esters compound.

9. The method of claim 1, wherein the compound having at least one carbon-carbon unsaturated bond is an acrylate or methacrylate compound.

10. The method of claim 1, wherein the compound having at least one carbon-carbon unsaturated bond is an olefinic compound.

11. The method of claim 1, wherein the reaction between the S₂Cl₂ and a compound having at least one carbon-carbon unsaturated bond is performed at −15° C. to 125° C.

12. The method of claim 1, wherein the reaction between the S₂Cl₂ and a compound having at least one carbon-carbon unsaturated bond uses a solvent.

13. The method of claim 1, wherein the reaction between the S₂Cl₂ and a compound having at least one carbon-carbon unsaturated bond excludes a solvent.

14. The method of claim 1, wherein: (i) the compound containing sulfur and a halogen is disulfur dichloride (S₂Cl₂), sulfur dichloride, disulfur dibromide, sulfur dibromide, thionyl chloride, thionyl bromide or a combination thereof; (ii) the compound having at least one carbon-carbon unsaturated bond is a silane, a siloxane compound, an alkenyl ether compound, an alkenyl esters compound, an acrylate, or a methacrylate compound; and (iii) a mole ratio between (1) the compound containing sulfur and a halogen and (2) the compound having at least one carbon-carbon unsaturated bond is between 1:3 to 7:1.

15. The method of claim 1, wherein: (i) wherein the compound containing sulfur and a halogen is disulfur dichloride (S₂Cl₂), sulfur dichloride, disulfur dibromide, sulfur dibromide, thionyl chloride, thionyl bromide or a combination thereof; (ii) the compound having at least one carbon-carbon unsaturated bond is an olefinic compound; and (iii) the weight ratio between (1) the compound containing sulfur and a halogen and (2) the olefinic compound is at minimum 1 to 28 and at maximum 6 to 1.

16. The method of claim 1, wherein the total amount of the compound having at least one carbon-carbon unsaturated bond is from 0.5 mmol to 7.5 mmol per 100 grams of the polydiene solution.

17. The method of claim 1, wherein the elastomer is characterized by an increase of at least 35% in Mooney viscosity (ML 1+4 at 100° C.) compared to the Mooney viscosity of the elastomer without the addition of (1) the compound containing sulfur and a halogen and (2) the compound having at least one carbon-carbon unsaturated bond.

18. The method of claim 1, wherein the elastomer is characterized by an increase of at least 5% in molecular weight compared to the molecular weight of the elastomer without the addition of (1) the compound containing sulfur and a halogen and (2) the compound having at least one carbon-carbon unsaturated bond.

19. The method of claim 1, wherein the elastomer is functionalized.

20. A tire having a tread or carcass compound comprising at least the polymer of claim 1.
